(19) United States
(12) Patent Application Publication
(10) Pub. No.: US 2026/0277715 A1
(43) Pub. Date: Sep. 17, 2026

(54) REMOTE PROCEDURE CALL REPLACEMENT WITH CERTAINTY GUARANTEES

(71) Applicant: Regatta Data Ltd., Bet Hanania (IL)

(72) Inventors: Hilla ATZMON, Haifa (IL); Irit YADIN-LEMPEL, Caesarea (IL)

(73) Assignee: Regatta Data Ltd., Bet Hanania (IL)

(21) Appl. No.: 19/079,927

(22) Filed: Mar. 14, 2025

(51) Int. Cl. G06F 9/54

(52) U.S. Cl. CPC G06F 9/547

(57) ABSTRACT

A system and method for a remote procedure call are provided. The method includes brokering client-server communications, wherein client-server communications include a client’s request message for an operation, a server’s response message with the results of the operation, and a purge message acknowledging receipt of the results; establishing, through system messages, time-frames for client-server communications, wherein time-frames are established to enable detection of client-server communications that have not been timely received; tagging the client-server communications with time-frame numbers corresponding to the time-frames in which each client-server communication is sent; detecting that at least one client-server communication, sent in one time-frame, is not received in a pre-determined number of subsequent time-frames; and retransmitting the at least one client-server communication.

### TECHNICAL FIELD

The present disclosure relates generally to methods for performing remote procedure calls.

### BACKGROUND

Remote Procedure Calls (RPCs) are a construct in distributed computing, enabling a client on one computer to request the execution of a procedure on a server located on a different computer. This mechanism abstracts the complexity of network communication, allowing developers to invoke remote services as if they were local function calls. When a client initiates an RPC, it sends a request to the server, specifying the procedure to be executed along with any necessary parameters. The server processes this request, executes the specified procedure, and returns the result to the client. This interaction facilitates seamless communication and coordination between distributed systems, making it easier to build scalable and modular applications.

However, current RPC technology faces a number of challenges. One significant issue is the uncertainty surrounding response times. The client often has no way of knowing how long it will take for the server to process the request and return a response. In the absence of a timely response, the client may encounter a timeout error, leading to confusion about whether the request or the response was lost. This uncertainty is further complicated by long-running operations, where the client might abandon the original request and resend it, potentially leading to duplicate requests and "ghost" responses—responses to the original request arriving after the client has already moved on, which can interfere with ongoing processes.

From the server's perspective, handling retransmitted requests can be problematic, especially for operations that require significant resources or alter persistent states. If the server receives a retransmitted request while still processing the original or after completing it, it must ensure that the operation is not executed multiple times. Additionally, the server has no inherent way of knowing if its response was successfully received by the client. In the case of long operations, servers often send immediate acknowledgments to inform the client that the operation is in progress. This requires the client to either poll for completion or the server to send a final response once the operation is complete, adding complexity and increasing the number of messages exchanged. These interactions may result in endless loops of uncertainty.

Additionally, an application utilizing the RPC must be programmed to support this communication protocol and the deficiencies noted above, which adds complexity for the application programmer and increases the likelihood of bugs, omissions, oversights, and unnecessary work.

It would, therefore, be advantageous to provide a solution that would overcome the deficiencies noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a method for a remote procedure call. The method comprises: brokering client-server communications, wherein client-server communications include a client’s request message for an operation, a server’s response message with the results of the operation, and a purge message acknowledging receipt of the results; establishing, through system messages, time-frames for client-server communications, wherein a system message is a control message or an acknowledgement message, and wherein time-frames are established to enable detection of client-server communications that have not been timely received; tagging the client-server communications with time-frame numbers corresponding to the time-frames in which each client-server communication is sent; detecting that at least one client-server communication, sent in one time-frame, is not received in a pre-determined number of subsequent time-frames; and retransmitting the at least one client-server communication.

Certain embodiments disclosed herein also include a non-transitory computer readable medium having stored a set of instructions for a remote procedure call, the set of instructions comprising: brokering client-server communications, wherein client-server communications include a client’s request message for an operation, a server’s response message with the results of the operation, and a purge message acknowledging receipt of the results; establishing, through system messages, time-frames for client-server communications, wherein a system message is a control message or an acknowledgement message, and wherein time-frames are established to enable detection of client-server communications that have not been timely received; tagging the client-server communications with time-frame numbers corresponding to the time-frames in which each client-server communication is sent; detecting that at least one client-server communication, sent in one time-frame, is not received in a pre-determined number of subsequent time-frames; and retransmitting the at least one client-server communication.

Certain embodiments disclosed herein also include a system for a remote procedure call. The system comprises: a processing circuitry; and a memory, the memory containing instructions that, when executed by the processing circuitry, configure the system to: broker client-server communications, wherein client-server communications include a client’s request message for an operation, a server’s response message with the results of the operation, and a purge message acknowledging receipt of the results; establish, through system messages, time-frames for client-server communications, wherein a system message is a control message or an acknowledgement message, and wherein time-frames are established to enable detection of client-server communications that have not been timely received; tag the client-server communications with time-frame numbers corresponding to the time-frames in which each client-server communication is sent; detect that at least one client-server communication, sent in one time-frame, is not received in a pre-determined number of subsequent time-frames; and retransmit the at least one client-server communication.

Certain embodiments disclosed herein include the method, non-transitory computer readable medium, or system noted above or below, wherein brokering the client-server communications, further including or being configured to perform the following step or steps: establishing a client communication engine on a client, wherein the client communication engine is configured to transmit request messages, purge messages, and control messages; and establishing a server communication engine on a server, wherein the server communication engine is configured to transmit response messages and acknowledgement messages.

Certain embodiments disclosed herein include the method, non-transitory computer readable medium, or system noted above or below, wherein establishing time-frames, further including or being configured to perform the following step: tagging system messages with time-frame numbers corresponding to a time-frame in which each system message is sent.

Certain embodiments disclosed herein include the method, non-transitory computer readable medium, or system noted above or below, further including or being configured to perform the following step or steps: incrementing the time-frame number of a control message only upon receiving an acknowledgement message tagged with a time-frame number from the immediately preceding time-frame, wherein receiving the acknowledgement message indicates that a control message from the immediately preceding time-frame was received.

Certain embodiments disclosed herein include the method, non-transitory computer readable medium, or system noted above or below, wherein establishing time-frames, further including or being configured to perform the following step or steps: sending control messages at regular intervals.

Certain embodiments disclosed herein include the method, non-transitory computer readable medium, or system noted above or below, wherein retransmitting the at least one client-server communication, further including or being configured to perform the following step or steps: aggregating the at least one client-server communication onto a next system message, wherein the next system message is a system message that is sent after detecting that the at least one client-server communication was not received.

Certain embodiments disclosed herein include the method, non-transitory computer readable medium, or system noted above or below, wherein retransmitting the at least one client-server communication, further including or being configured to perform the following step: sending a separate re-transmission of the at least one client-server communication.

Certain embodiments disclosed herein include the method, non-transitory computer readable medium, or system noted above or below, wherein detecting that at least one client-server communication, sent in one time-frame, is not received in a pre-determined number of subsequent time-frames, further including or being configured to perform the following step or steps: detecting that the time-frame number tagged onto a message of the client-server communication is a pre-determined number of time-frames earlier than the current time-frame.

Certain embodiments disclosed herein include the method, non-transitory computer readable medium, or system noted above or below, wherein the request message includes which operation is called and the parameters for the operation.

Certain embodiments disclosed herein include the method, non-transitory computer readable medium, or system noted above or below, further including or being configured to perform the following step or steps: receiving a request message, tagged with a first time-frame number, for an operation; when a response for the operation is not received before the receipt of a control message tagged with a third time-frame number, performing: attaching a confirmation of receipt of the request to an acknowledgement message tagged with a third time-frame number, wherein the confirmation of receipt indicates the request message for the operation was received by the server communication engine; and sending the acknowledgement message with the attached confirmation of receipt to the client communication engine, wherein sending the acknowledgement message confirms to the client communication engine that the request message was received.

Certain embodiments disclosed herein include the method, non-transitory computer readable medium, or system noted above or below, further including or being configured to perform the following step or steps: when a re-transmission of the client request message is received after receipt of the control message tagged with a third time-frame number: discarding the request message.

Certain embodiments disclosed herein include the method, non-transitory computer readable medium, or system noted above or below, further including or being configured to perform the following step or steps: receiving a request message, tagged with a first time-frame number, for an operation; when a response message for the operation is not received before the receipt of an acknowledgement message tagged with a third time-frame number and with no attached confirmation of receipt: detecting that the request was not received by a server communication engine; and re-transmitting the request message, tagged with a third time-frame number, to the server communication engine.

Certain embodiments disclosed herein include the method, non-transitory computer readable medium, or system noted above or below, further including or being configured to perform the following step or steps: identifying a response message for the operation is sent before the receipt of a control message tagged with a third time-frame number but is received by a client communication engine after the retransmission of the request message; and discarding the re-transmitted request message.

Certain embodiments disclosed herein include the method, non-transitory computer readable medium, or system noted above or below, further including or being configured to perform the following step or steps: receiving a request message at a server communication engine for an operation; sending a response message, tagged with a first time-frame number, to a client communication engine; detecting an absence of an acknowledgement of receipt of the response message sent by the client communication engine to the server communication engine, wherein the absence of an acknowledgement of receipt indicates that a purge message tagged with a first time-frame number is either not sent by the client communication engine or not received by the server communication engine; attaching the response message for the operation to an acknowledgement message tagged with a third time-frame number; sending the acknowledgement message tagged with the third time-frame number and attached with the response message for the operation; and transmitting an acknowledgement of receipt of the response message by the client communication engine to the server communication engine, wherein the acknowledgement of receipt is a purge message tagged with a third time-frame number.

Certain embodiments disclosed herein include the method, non-transitory computer readable medium, or system noted above or below, wherein when the transmission of the acknowledgement of receipt of the response message by the client communication engine is not received by the server communication engine: sending a control message, tagged with a fourth time-frame number, by the client communication engine to the server communication engine; implicitly detecting, by the server communication engine, that the acknowledgement message tagged with the third time-frame number and attached with the response message was received by the client communication engine, wherein implicitly detecting is based on the receipt of the control message tagged with a fourth time-frame number by the server communication engine; and sending a purge operation, by the server communication engine, to the server.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram utilized to describe various disclosed embodiments.

FIG. 2 illustrates a high-level framework of a communications framework for managing client-server communications for a remote procedure call according to an embodiment.

FIG. 3 is an overview of a time-frame protocol configured to manage client-server communications for a modified remote procedure call according to an embodiment.

FIG. 4 is a flow diagram illustrating a time-frame protocol for tagging request, response, and purge messages with time-frame numbers corresponding to time-frames initiated in time-frame protocol according to an embodiment.

FIG. 5A is an example flow diagram of a client-server communication illustrating a message tagged with a time-frame number that is received by the server communication engine before the start of the time-frame at the server communication engine according to an embodiment.

FIG. 5B is an example flow diagram of a client-server communication illustrating a message tagged with a time-frame number that is sent from the client communication engine in one time-frame and received by the server communication engine in the subsequent time-frame at the server communication engine according to an embodiment.

FIG. 5C is an example flow diagram of a client-server communication illustrating a request-N that is sent by the client communication engine in one time-frame and received by the server communication engine more than one time-frame later at the server communication engine according to an embodiment.

FIG. 6 is an example flow diagram of a client-server communication in the time-frame protocol illustrating the use of a confirmation aggregated onto an acknowledgement message.

FIG. 7A is an example flow diagram of a client-server communication in the time-frame protocol illustrating the implicit detection of a lost request and the subsequent re-transmission of the request according to an embodiment.

FIG. 7B is an example flow diagram of a client-server communication in the time-frame protocol illustrating the case where a re-transmitted request message is ignored by the server communication engine when the client communication engine incorrectly inferred that the original request message was lost in transmission according to an embodiment.

FIG. 7C is an example flow diagram of a client-server communication in the time-frame protocol illustrating the implicit detection of a lost request and the re-transmission of the request by aggregating the request onto a control message sent by the client communication engine according to an embodiment.

FIG. 8A is an example client-server communication in the time-frame protocol illustrating implicit detection of a lost response and the re-transmission of the response by aggregating the response onto an acknowledgement message according to an embodiment.

FIG. 8B is an example flow diagram of a client-server communication in the time-frame protocol illustrating the implicit detection of a lost purge message according to an embodiment.

FIG. 8C is an example flow diagram of a client-server communication in the time-frame protocol illustrating the implicit detection of a lost response and the implicit acknowledgement of a lost purge message.

FIG. 9 is an example schematic diagram of a server in a database system according to an embodiment.

FIG. 10 illustrates an example flowchart of a process for managing client-server communications for a remote procedure call according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views

The various disclosed embodiments include a protocol and system that provides guarantees for the certainty of transmissions of messages between clients and servers. This protocol and system serve as a replacement for remote procedure calls. The various disclosed embodiments include a database system that includes a client communication engine and a server communication engine that are configured to offset the transmission of messages that would normally be performed, at the application layer, by clients and servers directly. Instead, the communication engines are configured to execute a time-frame protocol that confirms the transmission of such messages is not lost or delayed, freeing the clients and servers from dealing with ghost messages, delayed messages, re-transmitted messages, and lost messages by themselves, which would otherwise result in inefficient, duplicative, and slow data transmission. The time-frame protocol executed by the database system serves to mitigate these uncertainties and inefficiencies in data transmission by executing various techniques disclosed in more detail hereinbelow to deal with scenarios of delayed messages, lost messages, long operations, etc. without requiring the client or server to send unnecessarily duplicative messages, poll messages, status updates or multiple re-transmissions of the same messages, while also removing the burden and risk of programming this exception code from the application programmer. The disclosed system that executes the time-frame protocol serves to reduce the average number of transmitted messages when the client-server system is busy.

The disclosed invention provides a database system that includes a client communication engine established on a client and at least one server communication engine established on respective server nodes of a database (hereinafter referred to individually as a server and collectively as servers, merely for simplicity purposes) in a distributed database configuration, both communication engines configured to broker client-server communications between a respective client and server. According to an embodiment, a server communication engine receives request messages from a client communication engine for a particular server to perform an operation, e.g., index lookup, and to send response messages with the results of that particular operation. The time-frame protocol executed on the communication engines establishes time-frames to enable the communication engines to recognize when a request message, response message, or purge message for a particular operation is lost or delayed in transmission and to take an appropriate action, relieving the application of these responsibilities. The protocol involves tagging control messages and acknowledgment messages with a time-frame number as well as tagging the request, response, and purge messages with a time-frame number. Based on these time-frame numbers tagged onto certain messages at certain time intervals, the database system is able to explicitly or implicitly confirm receipt of messages by either the client or the server, obviating the need for the client or server to deal with re-transmissions at the application level.

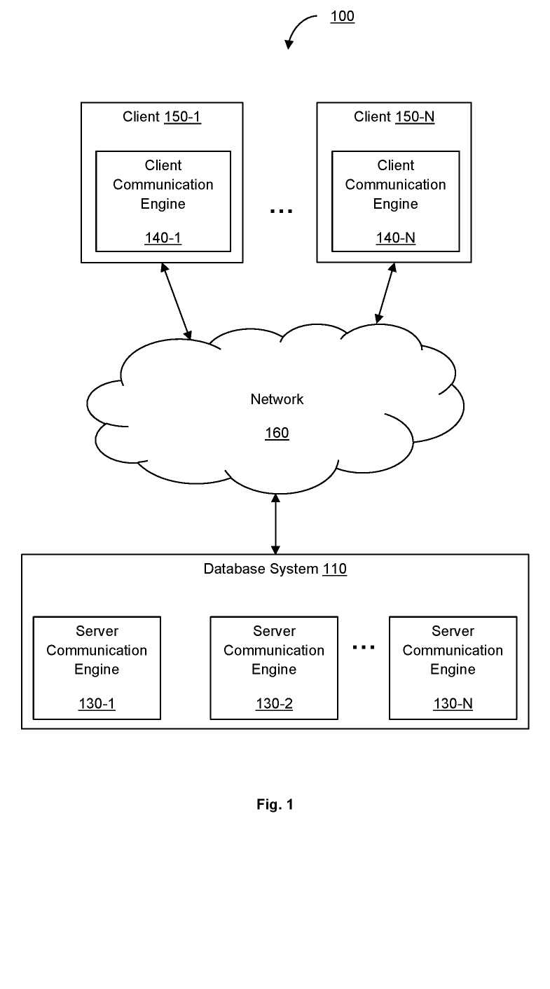

FIG. 1 shows an example network diagram 100 utilized to describe the various disclosed embodiments. In the example network diagram 100, a database system 110, client 150 (hereinafter referred to individually as a client 150 and collectively as clients 150, merely for simplicity purposes) communicate over a network 160. The network includes, but is not limited to, a wireless, cellular or wired network, a local area network (LAN), a wide area network (WAN), a metro area network (MAN), the Internet, the worldwide web (WWW), similar networks, and any combination thereof.

The database system 110 may instantiate a server communication engine 130 (hereinafter referred to individually as a server communication engine 130 and collectively as server communication engines 130, merely for simplicity purposes) on each server (not depicted in the example network diagram 100, for clarity purposes). Additionally, in an embodiment, the database system 110 instantiates a client communication engine 140 (hereinafter referred to individually as a client communication engine 140 and collectively as client communication engines 140, merely for simplicity purposes) on each client 150. Instantiating both communication engines by database system 110 serves to ensure that both communication engines properly execute a time-frame protocol that governs the communications between clients 150 and servers. In an embodiment, the time-frame protocol is established between one client communication engine 140 and one respective server communication engine 130. A client communication engine 140 and a server communication engine 130 broker the various operations of the disclosed replacement remote procedure call, thereby providing the certainty guarantees and robust delivery of client-server communications.

The server communication engine 130 and the client communication engine 140 may be realized in hardware, software, firmware, or a combination thereof. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). Additionally, the respective communication engines may be realized as a software object, a script, and the like executed over the hardware of a respective client or server.

Each server communication engine 130 is configured to receive messages including but not limited to request messages, purge messages and control messages (defined below) from a client communication engine 140; send those messages to the relevant server of the database system 110; and transmit messages including but not limited to response messages and acknowledgement messages from the respective server back to the relevant client communication engine 140. The handling of the receipt and transmittal of such messages by the server communication engine 130 in the database system 110 is executed according to various disclosed embodiments.

Each client communication engine 140 is configured to send messages including but not limited to request messages, purge messages, and control messages to a server communication engine 130 of the database system 110. Each client communication engine 140 is also configured to receive response messages and acknowledgment messages from database system 110 e.g., from the relevant server communication engine 130 associated with a server of the database system 110. The handling of the receipt and transmittal of such messages by the client communication engine 140 in the client 150 is executed according to various disclosed embodiments.

For example, in an embodiment, client 150 sends request messages for a server of the database system 110 to perform an operation e.g., an index lookup. The request message includes the operation and the parameters of the operation. Before the request message is sent to the server communication engine 130 associated with the server that is requested to perform the operation, the client communication engine 140 instantiated on the client 150 that made the request handles the message according to various disclosed embodiments. After the server receives the request message and performs the requested operation, the server communication engine 130 associated with the server handles the server’s response message, which includes results of the operation, according to various disclosed embodiments.

In an embodiment, the client communication engine 140 establishes numbered time-frames. A time-frame is established each time a control message tagged with that corresponding time-frame number is sent from the client communication engine 140 to the server communication engine 130. The same time-frame commences at the server communication engine 130 when the server communication engine 130 receives the control message tagged with that corresponding time-frame number. The establishment of subsequent time-frames occurs when a control message tagged with a subsequent time-frame number is sent. The client communication engine 140 also tags request messages and purge messages with time-frame numbers according to the time-frame in which the messages are sent.

Additionally, the server communication engine 130 tags acknowledgement messages and response messages with time-frame numbers according to the time-frame in which the messages are sent. Tagging a message with a time-frame number allows the communication engines to recognize the time-frame in which the message was sent; confirm whether a message was received, lost, or delayed; determine how the communication engines handle various scenarios where different messages are lost in transmission, delayed, etc.

Various embodiments disclosed herein discuss the various techniques for managing transmissions of messages in the framework of the network diagram 100 of FIG. 1.

The framework illustrated in network diagram 100, along with the various techniques executed by the client communication engine 140 and the server communication engine 130, serve to offset various network communication tasks from clients and servers to the respective communication engines, allowing the clients and servers to communicate to perform various operations, without having to manage network communication problems at the application level. The communication engines perform the various disclosed embodiments to guarantee certainty in the transmittal of messages in various scenarios.

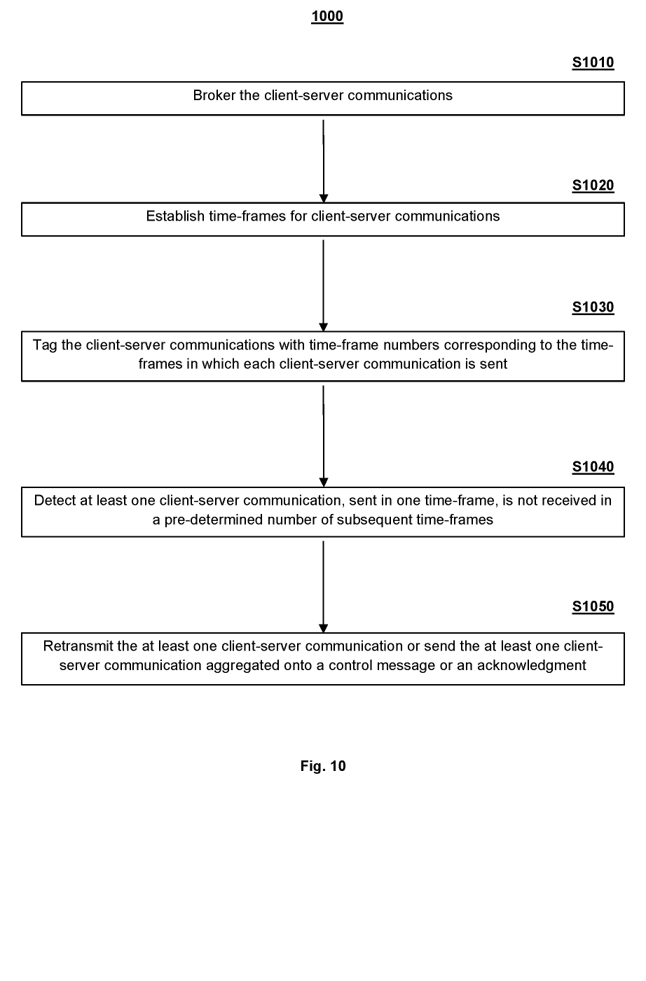

FIG. 10 illustrates an example flowchart 1000 of a process for managing client-server communications for a remote procedure call according to an embodiment. In an embodiment, the process is executed by the database system 110.

At S1010, client-server communications are brokered. In an embodiment, for example, the database system 110 may broker the client-server communications. The client-server communications include a client’s request message for an operation, a server’s response message with the results of the operation, and a purge message acknowledging receipt of the results.

In an embodiment, brokering client-server communications may include establishing communication engines on a client and a server that are configured to perform various techniques on the client-server communications described hereinbelow. According to an embodiment, a client communication engine is established on a client. The client communication engine is configured to transmit request messages, purge messages, and control messages. A server communication engine is established on a server. The server communication engine is configured to transmit response messages and acknowledgement messages.

In a further embodiment, there may be a plurality of server communication engines established on a plurality of servers of a database. According to this embodiment, each server communication engine may be established on a respective server, and each server communication engine is configured to broker the client-server communications to and from the respective server.

At S1020, time-frames for client-server communications are established. In an embodiment, time-frames are established to enable detection of client-server communications that are lost or delayed in transmission, or that require processing by the server that is longer than the length of some number of time-frames. For example, database system 110 may establish time-frames for client-server communications.

In an embodiment, time-frames are established by tagging control messages and acknowledgement messages with time-frame numbers corresponding to a time-frame in which each control message and acknowledgement message is sent. In a further embodiment, each time-frame commences, from the perspective of the client communication engine, upon sending a control message tagged with a particular time-frame number. The same time-frame commences, from the perspective of the server communication engine, upon receiving the control message tagged with the particular time-frame number.

At S1030, the client-server communications are tagged with time-frame numbers corresponding to the time-frames in which each client-server communication is sent. For example, database system 110 may tag the client-server communications with time-frame numbers corresponding to the time-frames in which each client-server communication is sent, as described above. According to such an embodiment, the client communication engine may tag request messages and purge messages sent from the client, and the server communication engine may tag response messages sent from the server. In an embodiment, tags are removed before messages are sent from either communication engine to their respective target entity e.g., tagged request messages received by server communication engine have tags removed before the message is sent to the server.

At S1040, at least one client-server communication, sent in one time-frame, is detected to not be received in a pre-determined number of subsequent time-frames. For example, database system 110 performs the detection. This detection, according to some embodiments, may be performed by either the client communication engine or the server communication engine. In an embodiment, the client communication engine can also explicitly detect requests that were not responded to within a defined number of time frames.

In an embodiment, either of the communication engines detects that the time-frame number tagged onto a message of the client-server communication is a pre-determined number of time-frames earlier than the current time-frame established.

In an embodiment, the detection of a time-frame number in a pre-determined number of time-frames earlier than the current time-frame also includes the detection, by one communication engine, that a message that has been sent in one time frame has not been responded to, by the other communication engine, in a pre-determined number of time-frames. For example, the detection may include that the message that was not responded to was lost in transmission.

In an embodiment, at least one client-server communication that was sent in one time-frame but not received within the next two time-frames is detected.

At S1050, a client-server communication is retransmitted, or a client-server communication aggregated onto a control message or an acknowledgment message is sent. For example, database system 110 may retransmit the at least one client-server communication or send the at least one client-server communication aggregated onto a control message or an acknowledgment message, as described in more detail below.

In an embodiment, the control message or the acknowledgment message that includes the aggregated at least one client-server communication is the next control message or acknowledgement message sent after detecting that the at least one client-server communication was not received.

Although FIG. 10 shows example blocks of process 1000, in some implementations, process 1000 may include additional blocks, fewer blocks, different blocks, or differently arranged blocks than those depicted in FIG. 10. Additionally, or alternatively, two or more of the blocks of process 1000 may be performed in parallel. The details of process 1000, according to various embodiments, are discussed further hereinbelow.

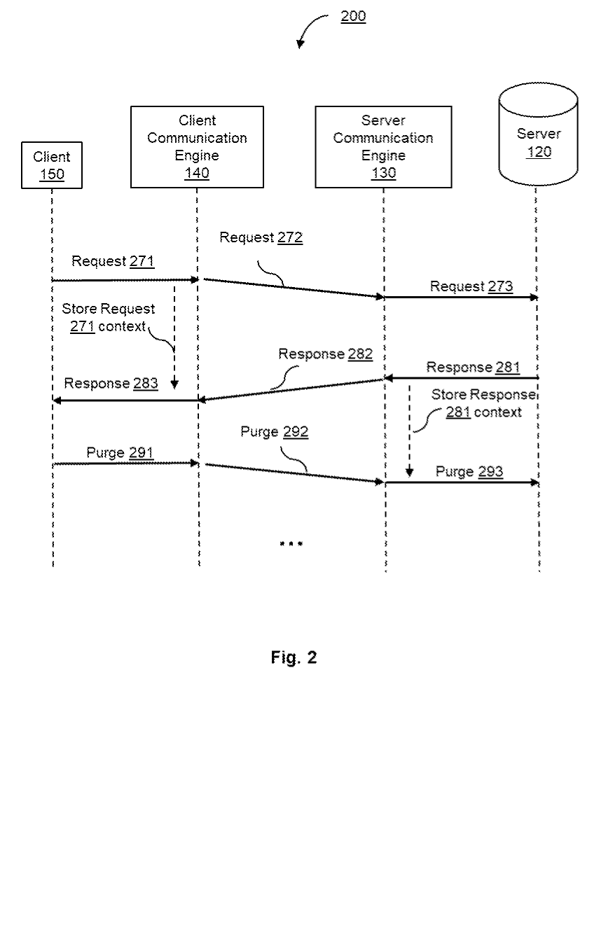

FIG. 2 illustrates a high-level framework 200 of a communications framework for managing client-server communications for a remote procedure call according to an embodiment. In an embodiment, the client communication engine 140 executes e.g., is deployed, in the client 150 and the server communication engine 130 executes e.g., is deployed, in the server 120. In an embodiment, the database system 110 instantiates the communication engines in the respective client or server. The database system 110 is configured to initiate the time-frame protocol on both communication engines. The communication engines are configured to broker communications between the client 150 and the server 120 based on the various techniques of the time-frame protocol initiated by the database system 110 and disclosed in more detail hereinbelow.

In an embodiment, a request 271 for an operation is sent from the client 150 to the server 120. The client communication engine 140 receives request 271 and sends request 272 to the server communication engine 130, which then sends request 273 for the operation to the server 120. The server 120 then is configured to perform the requested operation. The server 120 then sends a response 281 back to the server communication engine 130 with the contents of the results of the operation that the server 120 performed.

The server communication engine 130 receives the response 281 and sends response 282 to the client communication engine 140, which then sends response 283 to the client 150. The client 150 then sends a purge message 291 to the client communication engine 140. The client communication engine 140 receives the purge message 291 and sends purge message 292 to the server communication engine 130, which sends the purge message 293 to the server 120. The purge message is a message acknowledging receipt of the response 283 that originated from the server 120 as response 281. In an embodiment, the client communication engine 140 initiates the purge message 292 on receipt of the response 282.

In a further embodiment, the framework 200 is configured to store the details of the request 271 and the response 281, which serves to offset these responsibilities from the application level to the communication engines of the framework 200.

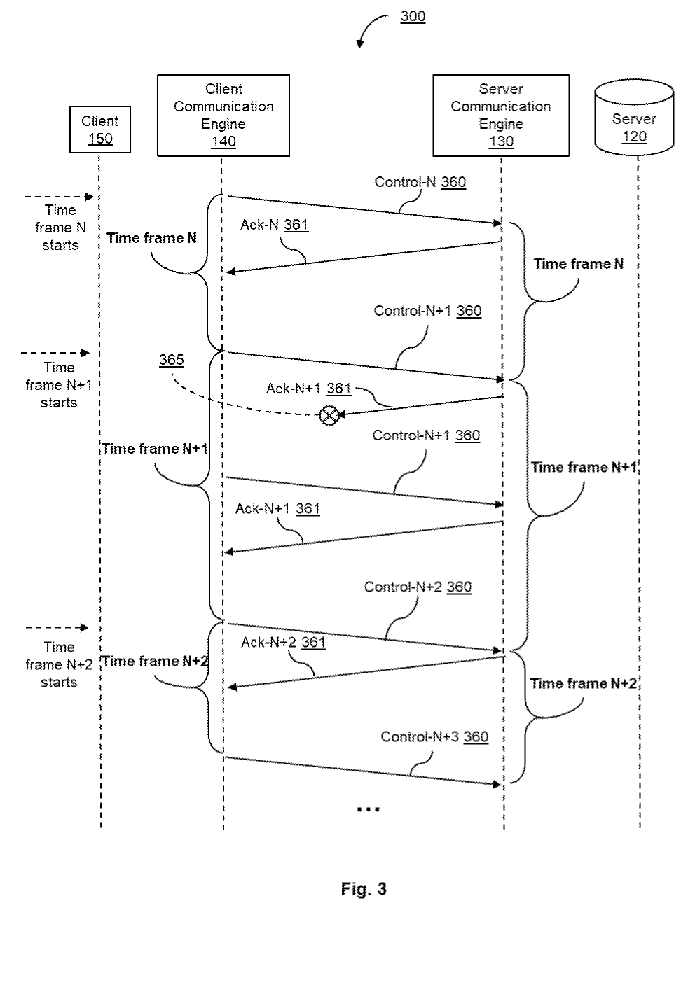

FIG. 3 is an overview of a time-frame protocol 300 configured to manage client-server communications for a modified remote procedure call according to an embodiment.

Time-frame N starts when the control message N 360 (hereinafter control-N 360) is sent by the client communication engine 140. The control-N 360 is tagged with the time-frame number N. Control-N 360 and subsequent controls-N+k 360 are messages used to impart time-frame information from the client communication engine to the server communication engine. In the examples described herein the parameters ‘N’ and ‘k’ are integer numbers equal to or greater than 1 unless otherwise stated.

Acknowledgement message N 361 (hereinafter ack-N 361) is sent by the server communication engine 130 in response to the receipt of the control-N 360 at the server communication engine 130. The ack-N 361 is a message acknowledging to the client communication engine 140 that the server communication engine 130 received the control-N 360. Ack-N 361 is tagged with the time-frame number N that was tagged to the received control-N 360.

Subsequent time-frames N+k start when the control-N+k 360 is sent by the client communication engine 140. The control and ack messages are tagged with a time-frame number corresponding to the subsequent time-frames N+k in which the control and ack messages are sent. For example, time-frame N+1 begins when the control-N+1360 is sent from the client communication engine 140 to the server communication engine 130.

In an embodiment, control-N+k 360 are sent at regular intervals e.g., periodically. The time-frame number increments (to the subsequent time-frame number) if and only if the ack message with the same time-frame tag as the most recent control message is received by the client communication engine 140. For example, an ack-N+1 361 is lost by an event 365. In such an embodiment, the time-frame N+1 is extended. The client communication engine 140 is unable to detect whether the control-N+1 360 was lost in transmission or the ack-N+1 361 was lost in transmission. Regardless of which message was lost, the control-N+1 360 is sent again from the client communication engine 140. The next time-frame (time-frame N+2) begins when control-N+2 360 is sent after ack-N+1 361 is received. The receipt of ack-N+1 361 guarantees to the client communication engine 140 that at least one control-N+1 360 was received by the server communication engine. Subsequent time-frames can be initiated indefinitely.

The client communication engine 140 is configured to ignore duplicated ack messages and ack messages that are tagged with time-frame numbers that are earlier than the time-frame number of the current time-frame, e.g., ack-N 360 received in time-frame N+1. Additionally, the server communication engine 130 is configured to ignore duplicated control messages and control messages that are tagged with time-frame numbers that are earlier than the time-frame number of the current time-frame, e.g., control 360-N received in time-frame N+1.

The time-frame protocol 300 is configured to perform various techniques, including explicit and implicit acknowledgement of receipt of messages, to ensure robust delivery of messages based on the time-frames and the time-frame numbers associated with the messages between the communication engines.

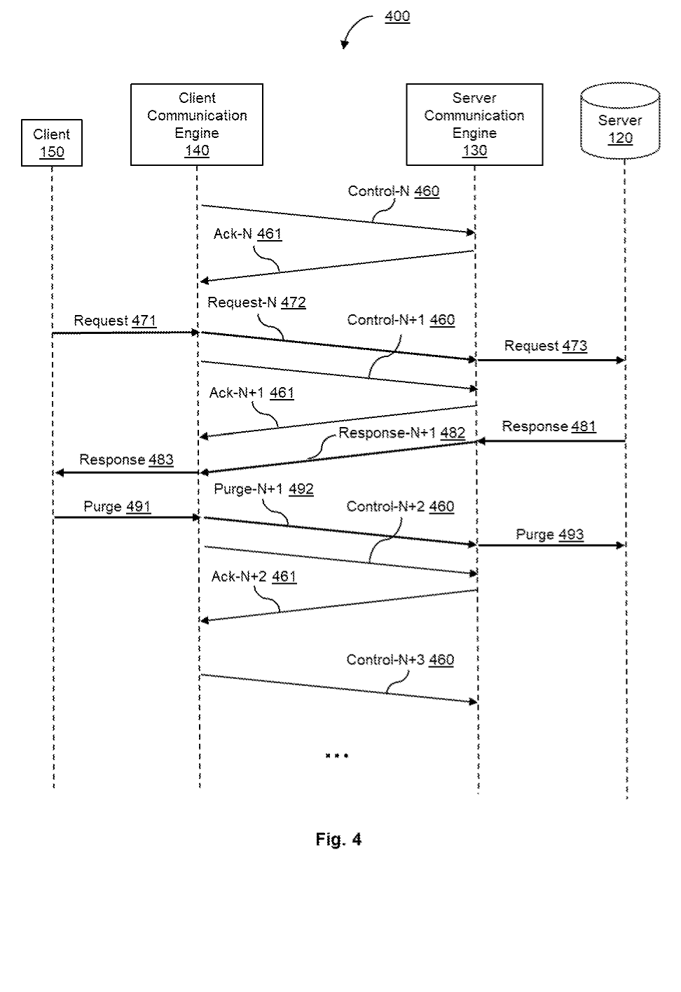

FIG. 4 is a flow diagram illustrating a time-frame protocol 400 for tagging request, response, and purge messages with time-frame numbers corresponding to time-frames initiated in time-frame protocol 300 according to an embodiment. In an embodiment, the protocol 400 illustrates a request sent in one time-frame and completed in a later time-frame. It should be noted that request, response and purge messages can all be completed within the same time-frame.

Request 471, sent in time-frame N, is tagged with the time-frame N. In an embodiment, the request 471 is sent from the client 150 and tagged with time-frame N by the client communication engine 140. The tagged request-N 472 is then sent to the server communication engine 130. The server communication engine 130 then sends request 473 to server 120. It should be noted that, in an embodiment, the tagging and un-tagging operations are performed by the communication engines. As such, in some configurations, the client 150 and server 120 do not perform those operations. The messages that the client 150 and server 120 send and receive are not yet tagged or the messages’ tags have been removed.

Request 471 is a message that includes an operation to be performed by the server 120 and the parameters of that operation to be performed. The server 120 receives the request 473 for this operation, performs the operation (not shown), and sends the results of the operation in a response 481.

Response 481, in this example, is sent in time-frame N+1 by the server 120. The response could be sent in the same time-frame as the request if the operation completes rapidly, or it could be sent in a later time-frame if the operation takes longer to complete. In an embodiment, the response 481 is sent from the server 120 and tagged with the current time-frame, N+1 in this example, by the server communication engine 130 and is sent as response-N+1 482 to the client communication engine 140. The client communication engine then sends response 483 to client 150.

Purge message 491, sent in time-frame N+1, is tagged with time-frame N+1. In an embodiment, the purge message 491 is sent from the client 150 and tagged with time-frame N+1 by the client communication engine 140 and sent as purge-N+1 492 to the server communication engine 130. In an alternate embodiment, the client communication engine 140 sends the purge-N+1 492 message as soon as the response-N+1 482 is received. The server communication engine 130 sends the purge message 493 to the server 120. The purge-N+1 492 confirms to the server communication engine 130 and ultimately to the server 120 that the client 150 received the response 481. The receipt of the purge-N+1 492 permits the release of resources by the server communication engine 130 and the server 120. In an alternative embodiment, the purge-N+1 492 may be aggregated onto control-N+2 460 (and sent with control-N+2 460) to save network traffic.

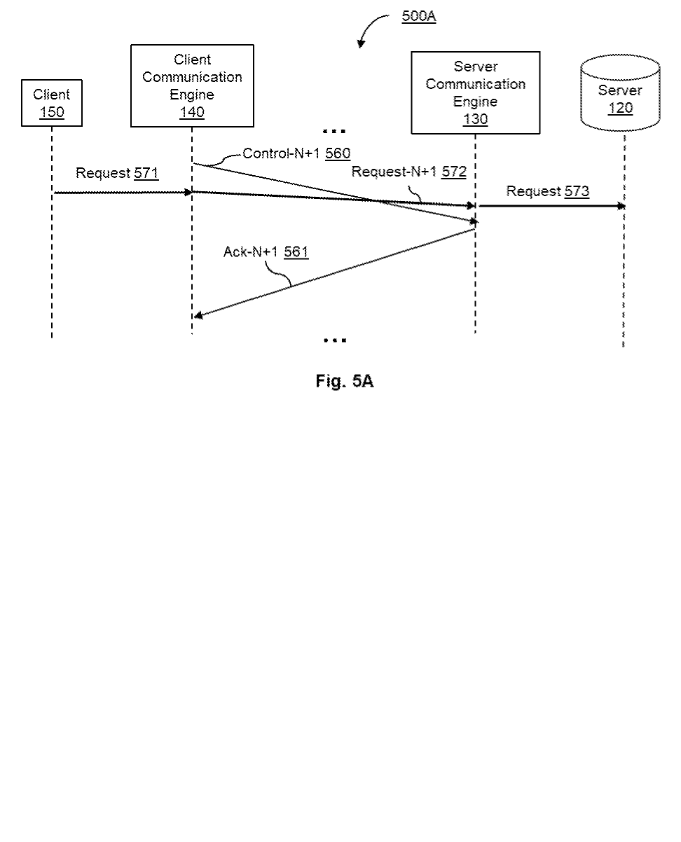

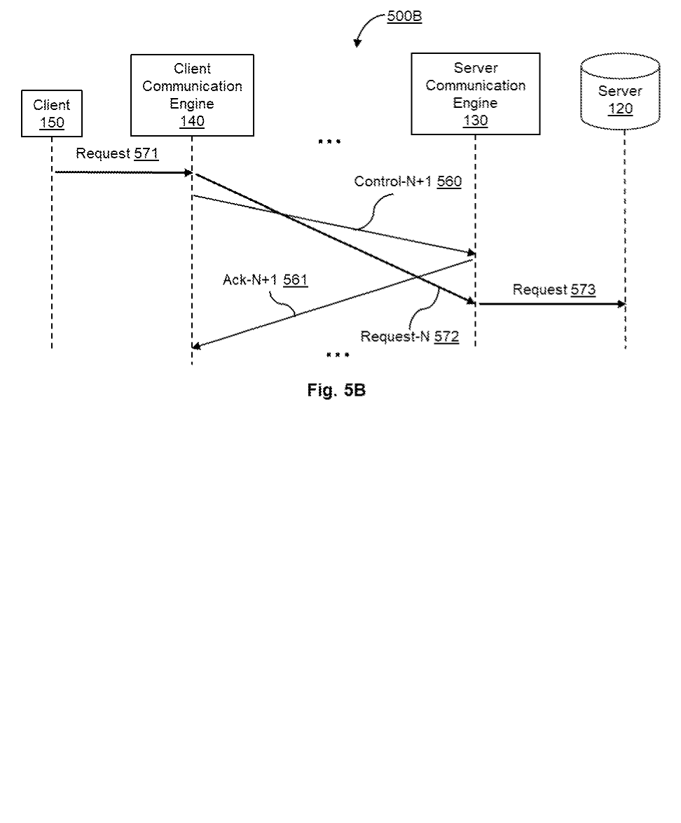

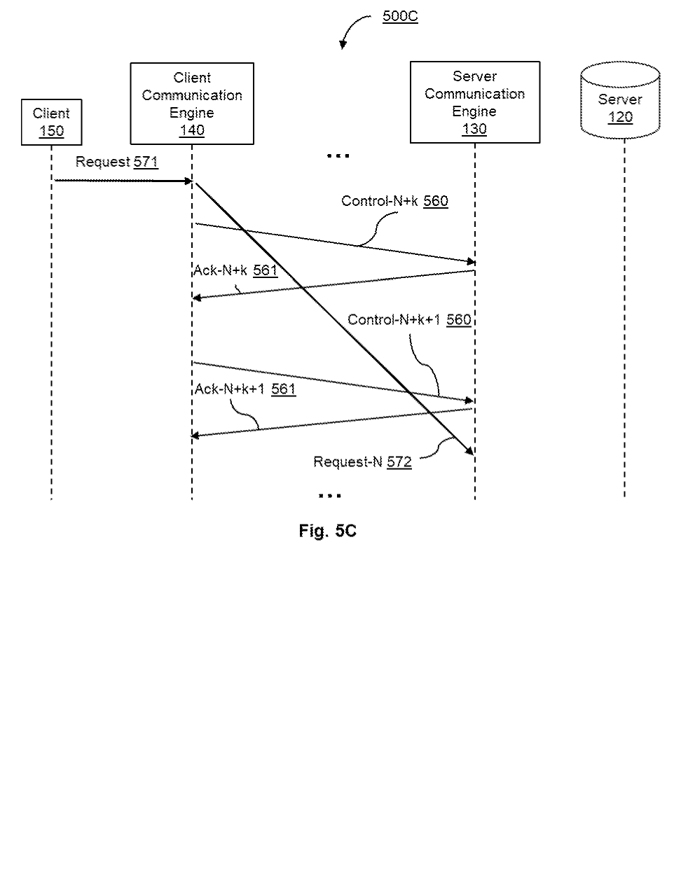

FIG. 5A is an example flow diagram of a client-server communication 500A illustrating a message tagged with a time-frame number that is received by the server communication engine 130 before the start of the time-frame at the server communication engine 130 according to an embodiment.

Time-frame N+1 is initiated, from the perspective of the client communication engine 140, upon the sending of the control-N+1 560 from the client communication engine 140. Time-frame N+1 is initiated, from the perspective of the server communication engine 130, upon receiving the control-N+1 560 from the client communication engine 140 at the server communication engine 130.

In the example client-server communication 500A, the request-N+1 572 is sent from the client communication engine 140 in time-frame N+1. However, the request is received at the server communication engine 130 before the start of time-frame N+1, that is, still in time-frame N. In an embodiment, the receipt of request-N+1 572 in the immediately preceding time-frame at the server communication engine 130 is permissible.

In an embodiment, a control message with an incremented time-frame number is sent only if the ack message of the previous time-frame was received by the client communication engine 140. In other words, according to this embodiment, a message cannot appear with a tag that is more than one time-frame in the future.

FIG. 5B is an example flow diagram of a client-server communication 500B illustrating a message tagged with a time-frame number that is sent from the client communication engine 140 in one time-frame and received by the server communication engine 130 in the subsequent time-frame at the server communication engine 130 according to an embodiment.

Time-frame N+1 is initiated, from the perspective of the client communication engine 140, upon the sending of the control-N+1 560 from the client communication engine 140. Time-frame N+1 is initiated, from the perspective of the server communication engine 130, upon receiving the control-N+1 560 from the client communication engine 140 at the server communication engine 130.

In the example client-server communication 500B, the request-N 572 is sent from the client communication engine 140 in time-frame N. However, the request is received at the server communication engine 130 after time-frame N (in time-frame N+1). In an embodiment, the receipt of request-N 572 in the immediately subsequent time-frame (N+1) at the server communication engine 130 is permissible. In other words, in an embodiment explained in more detail in FIG. 5C, request-N 572 received at the server communication engine 130 more than one time-frame later (time-frame N+2) is not permissible.

FIG. 5C is an example flow diagram of a client-server communication 500C illustrating a request-N 572 that is sent by the client communication engine 140 in one time-frame and received by the server communication engine 130 more than one time-frame later at the server communication engine 130 according to an embodiment. In an embodiment, such a message is ignored by the server communication engine 130.

Time-frame N+k is initiated, from the perspective of the client communication engine 140, upon the sending of the control-N+k 560 from the client communication engine 140. Time-frame N+k is initiated, from the perspective of the server communication engine 130, upon receiving the control-N+k 560 from the client communication engine 140 at the server communication engine 130.

In the example client-server communication 500C, the request-N 572 is sent from the client communication engine 140 in time-frame N. However, the request is received at the server communication engine 130 more than one time-frame after time-frame N (e.g., after the start of time-frame N+k+1). In an embodiment, request-N 572 is ignored by the server communication engine 130 and is not sent to the server 120.

It should be noted that the embodiments and flow diagrams discussed with respect to FIGS. 5A, 5B, and 5C are not limited to request messages. Response messages and purge messages may also be included in the embodiments of the time-frame protocol discussed in FIGS. 5A, 5B, and 5C.

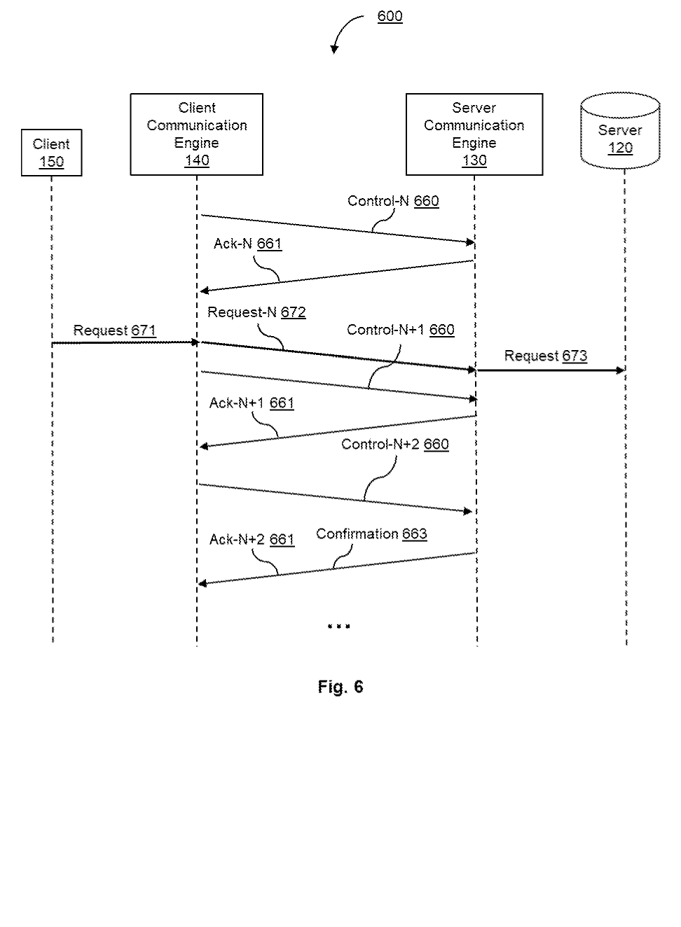

FIG. 6 is an example flow diagram of a client-server communication 600 in the time-frame protocol illustrating the use of a confirmation aggregated onto an acknowledgement message. In an embodiment, the time-protocol may detect that an operation is running for more than one time-frame, e.g., a long operation, according to an embodiment. In the case of a long operation, the disclosed example client-server communication 600 is executed to ensure certainty in the receipt of request messages between the client communication engine 140 and the server communication engine 130.

In an embodiment, the client communication engine 140 sends a request-N 672 in time-frame N, which is also received by the server communication engine 130 in time-frame N. The server communication engine 130 notes the operation and parameters of the operation in the request-N 672 as well as the tagged time-frame number N on the message request-N 672.

If no response was sent by server communication engine 130 to the client communication engine 140 by the end of the next time-frame (time-frame N+1), the server communication engine 130 aggregates a confirmation 663 onto to ack-N+2 661. Confirmation 663 is a confirmation that the server communication engine 130 received the request-N 672 even though there was not yet a response sent back to the client communication engine 140.

It should be noted that even if the request-N 672 is received within the time-frame of N+1, the confirmation 663 will still be aggregated with ack-N+2 661 (rather than with ack-N+3 661). This is when the client communication engine 140 is expecting confirmation. If this were not the case, the client communication engine 140 would initiate a retransmission upon receiving ack-N+2 661, as discussed below.

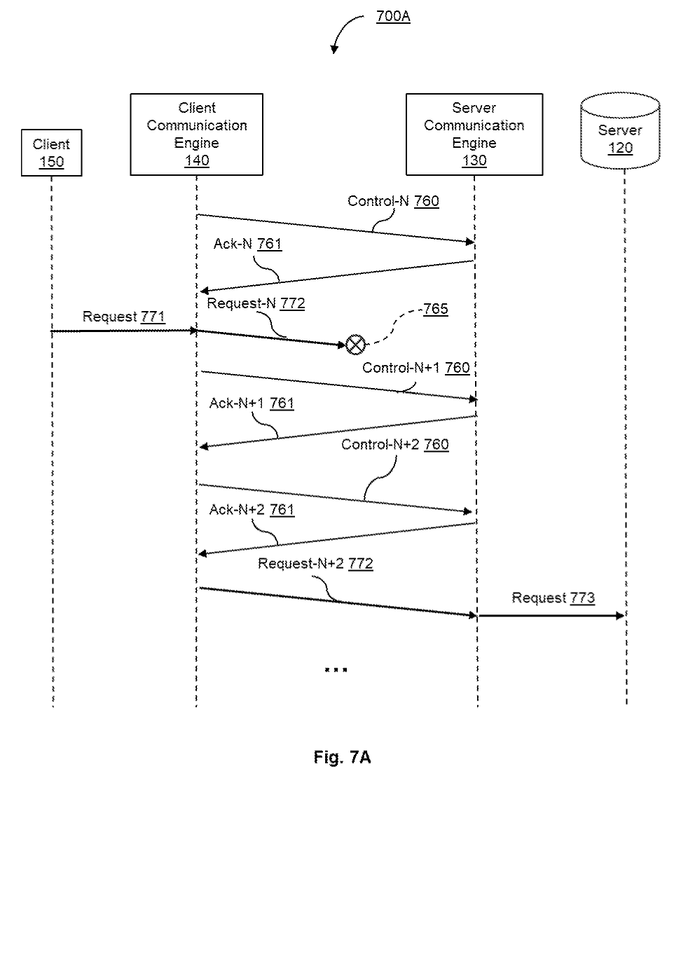

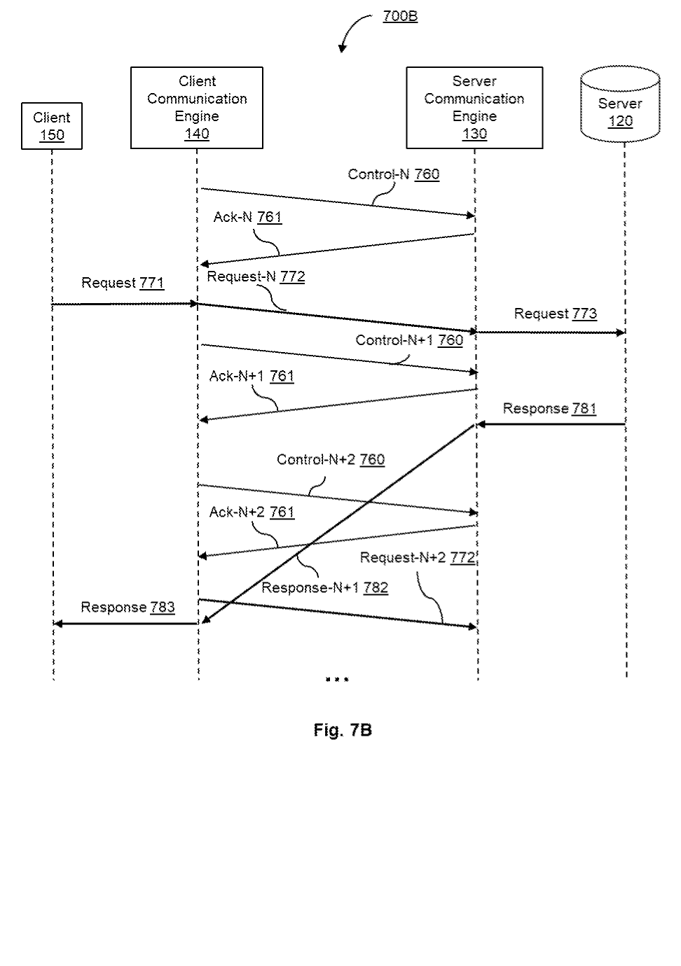

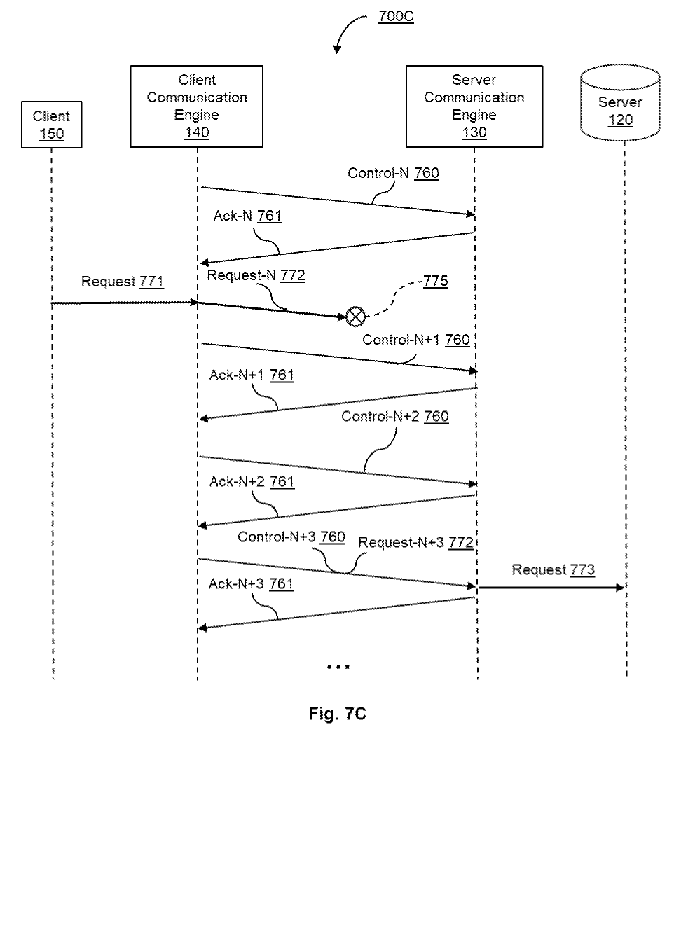

FIG. 7A is an example flow diagram of a client-server communication 700A in the time-frame protocol illustrating the implicit detection of a lost request and the subsequent re-transmission of the request according to an embodiment.

In an embodiment, after request-N 772 for an operation is sent to the server communication engine 130 in time-frame N, no response message from the server communication engine 130 is received prior to the receipt of the ack of time-frame N+2, nor does the ack of time-frame N+2 convey an aggregated confirmation of receipt of the request.

The time-frame protocol implicitly detects that the original request-N 772 was lost in transmission e.g., by an event 765, because neither of the above indications were received by the client communication engine 140 before the receipt of the ack of time-frame N+2. In such a case, the time-frame protocol, in various embodiments, is configured to re-transmit the request message. In an embodiment, the client communication engine 140 resends the request using the operation and parameters that client communication engine 140 received when the operation was first submitted. The client 150 is not involved and is unaware that a retransmission occurred, as this process is carried out by the time-frame protocol on behalf of the application, offsetting the burden of this responsibility from the application programmer. In the example client-server communication 700A, the request-N+2 772 is a request message for the same operation sent originally in request-N 772, but request-N+2 772 is tagged with the time-frame in which it is re-transmitted (time-frame N+2).

FIG. 7B is an example flow diagram of a client-server communication 700B in the time-frame protocol illustrating the case where a re-transmitted request message is ignored by the server communication engine 130 when the client communication engine 140 incorrectly inferred that the original request message was lost in transmission according to an embodiment.

According to this embodiment, the request-N 772 was transmitted from the client communication engine 140 and received by the server communication engine 130 in time-frame N. A response-N+1 782 was transmitted from the server communication engine 130 in time-frame N+1 but was received by the client communication engine 140 after ack-N+2 761. Illustrated in the example client-server communication 700B, the request-N+2 772 is a re-transmission of request-N 772 in time-frame N+2 because there was no response message received (yet) prior to the ack-N+2 761 nor was there a confirmation aggregated onto the ack-N+2 761.

This re-transmitted request-N+2 772 is “forgotten” by the client communication engine 140 once the client communication engine 140 receives the response-N+1 782 sent in the previous time-frame, indicating that the original request-N 772 was received by the server communication engine 130. The server communication engine 130 detects and ignores the retransmitted request-N+2 772 because a response to the original request was sent. This is another example of what is usually an application-level responsibility taken over by the time-frame protocol.

FIG. 7C is an example flow diagram of a client-server communication 700C in the time-frame protocol illustrating the implicit detection of a lost request and the re-transmission of the request by aggregating the request onto a control message sent by the client communication engine 140 according to an embodiment.

In an embodiment, after request-N 772 for an operation is sent to the server communication engine 130 in time-frame N, no response message with the results of the operation is received in time-frame N+2 from the server communication engine 130 and no confirmation message was aggregated onto ack-N+2 761.

The time-frame protocol may implicitly detect that the original request-N 772 was lost in transmission e.g., by an event 775 either because no response was received by the client communication engine 140 before the end of time-frame N+2 or because no confirmation was aggregated onto ack-N+2 761. The time-frame protocol may also implicitly detect that if a response had been sent in time-frame N+1, it would be discarded as delayed after the start of time-frame N+3, that is, the response would be discarded by the client communication engine because it had been delayed more than a full time-frame.

According to this embodiment of the time-frame protocol, the request-N+3 772 is aggregated onto the control-N+3 760. Request-N+3 772 is a request message for the same operation sent originally in request-N 772, but the request-N+3 772 is tagged with the time-frame in which it is re-transmitted (time-frame N+3). The ack-N+3 761 confirms the receipt of the retransmitted request-N+3 772 implicitly in the same way that the ack-N+2 761 would have confirmed if the request had been received by the server communication engine 130 but the response not yet sent, that is, the same purpose as the explicit aggregation of confirmation 663 on ack-N+2 661 in FIG. 6.

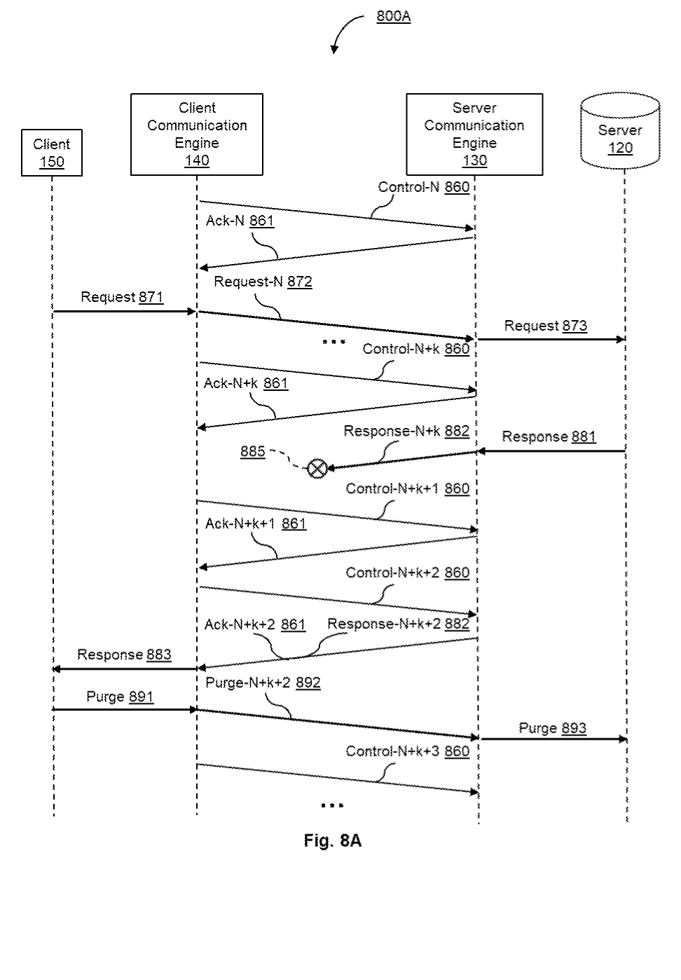

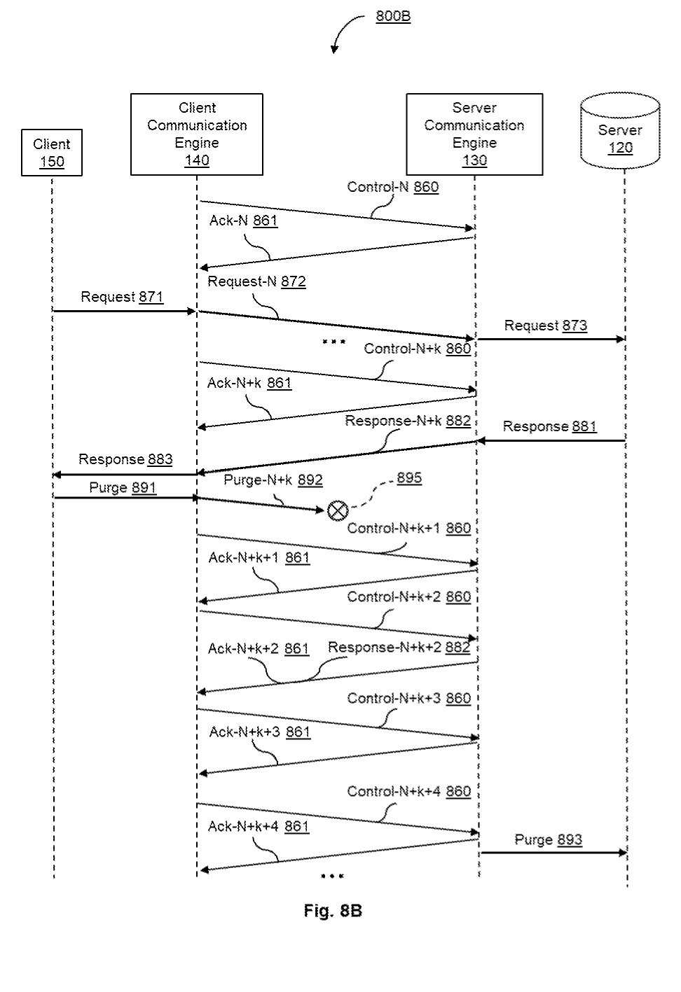

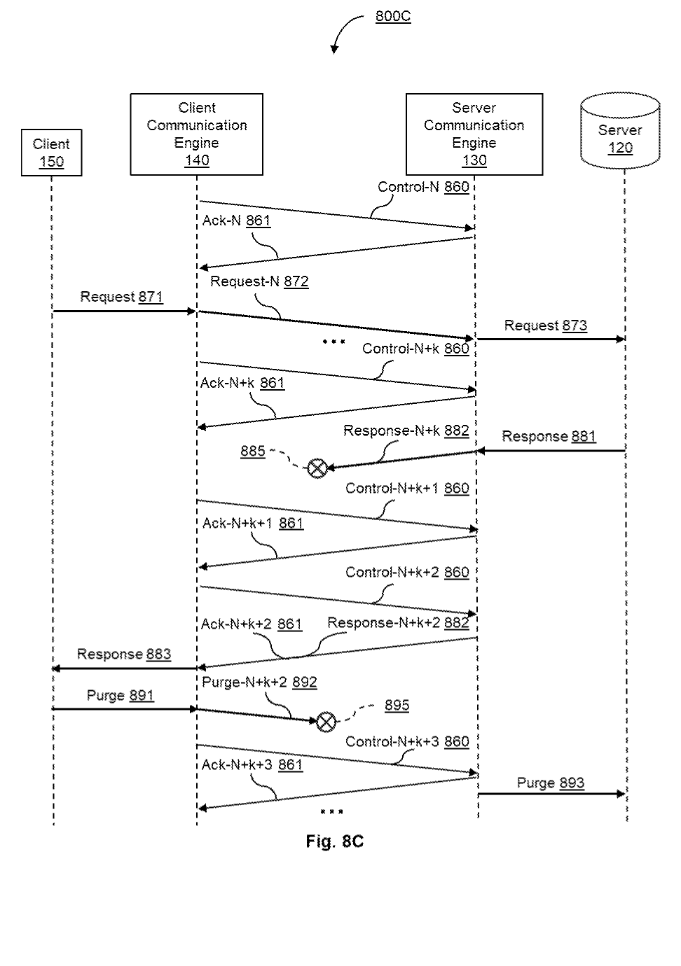

FIG. 8A is an example client-server communication 800A in the time-frame protocol illustrating implicit detection of a lost response and the re-transmission of the response by aggregating the response onto an acknowledgement message according to an embodiment.

In an embodiment, the request-N 872 for an operation is sent from the client communication engine 140 to the server communication engine 130 in time-frame N. The results of the operation are sent in response-N+k 882, where ‘k’ is an integer equal to or greater than 0. If k is greater than 1, then a confirmation would have been aggregated onto ack-N+2 861 (not shown). The response-N+k 882 is lost in transmission e.g. by an event 885. The server communication engine 130 does not receive a purge-N+k 892, from the client communication engine 140.

The server communication engine 130 detects the absence of a purge message in the next time-frame from when the response was sent (time-frame N+k+1) and infers that the client communication engine 140 did not receive the response-N+k 882 or that the purge message was lost. The receipt of such a purge message would have been an acknowledgement sent from the client communication engine 140 of receipt of the response-N+k 882.

The server communication engine 130, having received no purge message, aggregates the response-N+k+2 882 onto the ack-N+k+2 861 in the next time-frame (N+k+2). Response-N+k+2 882 includes the same results for the operation in the response-N+k882. The client communication engine 140 sends the response 883 to the client 150. Once the client 150 receives the response 883, the client 150 sends the purge message 891 to the client communication engine 140, and the client communication engine 140 sends the purge-N+k+2 892 along to the server communication engine 130, that sends purge 893 to the server 120. Aggregating response-N+k+2 882 onto the ack-N+k+2 861, as explained above, serves to save network traffic.

FIG. 8B is an example flow diagram of a client-server communication 800B in the time-frame protocol illustrating the implicit detection of a lost purge message according to an embodiment.

In an embodiment, request-N 872 is received, and response-N+k 882 is subsequently sent, where ‘k’ is an integer equal to or greater than 0, by the server communication engine 130. Upon receiving the response-N+k 882, client communication engine 140 sends the response 883 to the client 150 and a purge-N+k 892 is sent to the server communication engine 130.

The purge-N+k 892 is lost in transmission e.g., by an event 895, and is not received by the server communication engine 130 before the end of time-frame N+ k+1. The server communication engine 130 infers either that the response-N+k 882 is lost or the purge-N+k 892 is lost, but it cannot determine which is lost.

The response-N+k+2 882 is re-transmitted by aggregating onto the ack-N+k+2 861. In an embodiment, this is performed by the server communication engine 130. Once the time-frame is incremented to N+k+3 through the transmission of the control-N+k+3 860 by the client communication engine 140, the server communication engine 130 detects that the receipt of the control-N+k+3 860 at the server communication engine 130 means that the aggregated response-N+k+2 882 was received. The receipt of control-N+k+4 860 allows the server communication engine 130 to correctly infer that the purge-N+k892 was lost, and the server communication engine 130 infers receipt of the purge message at time-frame N+k+4.

FIG. 8C is an example flow diagram of a client-server communication 800C in the time-frame protocol illustrating the implicit detection of a lost response and the implicit acknowledgement of a lost purge message.

The lost response is re-transmitted through aggregation onto the ack-N+k+2 861 as explained in FIG. 8A. The lost purge message is implicitly acknowledged as explained in FIG. 8B. In an embodiment, while sending the purge message is not necessary, sending the purge messages enables the release of resources from the server at a time earlier than if the purge message were not sent, but inferred by the receipt of subsequent control messages.

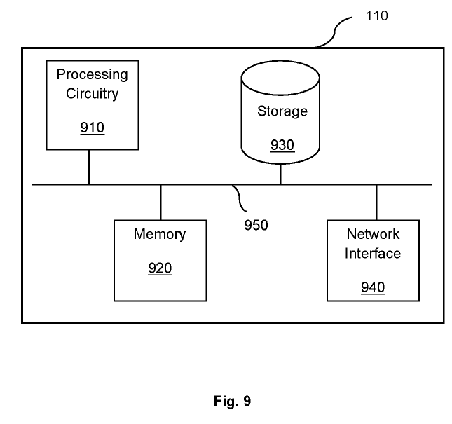

FIG. 9 is an example schematic diagram of a server in a database system 110 according to an embodiment. The database system 110 executes the server communication engines discussed above. The database system 110 includes a processing circuitry 910 coupled to a memory 920, a storage 930, and a network interface 940. In an embodiment, the components of the database system 110 may be communicatively connected via a bus 950.

The processing circuitry 910 may be realized as one or more hardware logic components and circuits. For example, and without limitation, illustrative types of hardware logic components that can be used include field programmable gate arrays (FPGAs), application-specific integrated circuits (ASICs), application-specific standard products (ASSPs), system-on-a-chip systems (SOCs), graphics processing units (GPUs), tensor processing units (TPUs), general-purpose microprocessors, microcontrollers, digital signal processors (DSPs), and the like, or any other hardware logic components that can perform calculations or other manipulations of information.

The memory 920 may be volatile (e.g., random access memory, etc.), non-volatile (e.g., read only memory, flash memory, etc.), or a combination thereof.

In one configuration, software for implementing one or more embodiments disclosed herein may be stored in the storage 930. In another configuration, the memory 920 is configured to store such software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 910, cause the processing circuitry 910 to perform the various processes described herein.

The storage 930 may be magnetic storage, optical storage, and the like, and may be realized, for example, as flash memory or other memory technology, compact disk- read only memory (CD-ROM), Digital Versatile Disks (DVDs), or any other medium which can be used to store the desired information.

The network interface 940 allows the database system 110 to communicate with, for example, the client 150, and the like.

It should be understood that the embodiments described herein are not limited to the specific architecture illustrated in FIG. 9, and other architectures may be equally used without departing from the scope of the disclosed embodiments. It should be further noted that the same hardware architecture shown in FIG. 9 can be of a client device executing the client communication engine.

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various embodiments disclosed herein can be implemented as hardware, firmware, software, or any combination thereof. Moreover, the software may be implemented as an application program tangibly embodied on a program storage unit or computer-readable medium consisting of parts or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

What is claimed is:

1. A method for a remote procedure call, comprising:
brokering client-server communications, wherein client-server communications include a client’s request message for an operation, a server’s response message with results of the operation, and a purge message acknowledging receipt of the results;
establishing, through system messages, time-frames for client-server communications, wherein time-frames are established to enable detection of client-server communications that have not been timely received;
tagging the client-server communications with time-frame numbers corresponding to the time-frames in which each client-server communication is sent;
detecting that at least one client-server communication, sent in one time-frame, is not received in a pre-determined number of subsequent time-frames; and
retransmitting the at least one client-server communication.

2. The method of claim 1, wherein brokering the client-server communications further comprises:
establishing a client communication engine on a client, wherein the client communication engine is configured to transmit request messages, purge messages, and control messages; and
establishing a server communication engine on a server, wherein the server communication engine is configured to transmit response messages and acknowledgement messages, wherein a system message is a control message or an acknowledgement message.

3. The method of claim 1, wherein establishing time-frames further comprises: tagging system messages with time-frame numbers corresponding to a time-frame in which each system message is sent.

4. The method of claim 3, further comprising:
incrementing a time-frame number of a control message only upon receiving an acknowledgement message tagged with a time-frame number from an immediately preceding time-frame, wherein receiving the acknowledgement message indicates that a control message from the immediately preceding time-frame was received.

5. The method of claim 1, wherein establishing time-frames further comprises: sending control messages at regular intervals.

6. The method of claim 1, wherein retransmitting the at least one client-server communication further comprises:
aggregating the at least one client-server communication onto a next system message, wherein the next system message is a system message that is sent after detecting that the at least one client-server communication was not received.

7. The method of claim 1, wherein retransmitting the at least one client-server communication further comprises:
sending a separate re-transmission of the at least one client-server communication.

8. The method of claim 1, wherein detecting that at least one client-server communication, sent in one time-frame, is not received in a pre-determined number of subsequent time-frames, further comprises:
detecting that the time-frame number tagged onto a message of the client-server communication is a pre-determined number of time-frames earlier than a current time-frame.

9. The method of claim 1, wherein the request message includes which operation is called and parameters for the operation.

10. The method of claim 2, further comprising:
receiving a request message, tagged with a first time-frame number, for an operation;
when a response for the operation is not received before the receipt of a control message tagged with a third time-frame number, performing:
attaching a confirmation of receipt of the request message to an acknowledgement message tagged with a third time-frame number, wherein the confirmation of receipt indicates the request message for the operation was received by the server communication engine; and
sending the acknowledgement message with the attached confirmation of receipt to the client communication engine, wherein sending the acknowledgement message confirms to the client communication engine that the request message was received.

11. The method of claim 2, further comprising: when a re-transmission of the request message is received after receipt of a control message tagged with a third time-frame number:
discarding the request message.

12. The method of claim 2, further comprising:
receiving a request message, tagged with a first time-frame number, for an operation;
when a response message for the operation is not received before the receipt of an acknowledgement message tagged with a third time-frame number and with no attached confirmation of receipt:
detecting that the request was not received by the server communication engine; and
re-transmitting the request message, tagged with a third time-frame number, to the server communication engine.

13. The method of claim 12, further comprising:
identifying a response message for the operation is sent before the receipt of a control message tagged with a third time-frame number but is received by the client communication engine after the re-transmission of the request message; and
discarding the re-transmitted request message.

14. The method of claim 12, wherein the request message is attached to and retransmitted with a control message tagged with a fourth time-frame number.

15. The method of claim 2, further comprising:
receiving a request message at the server communication engine for an operation;
sending a response message, tagged with a first time-frame number, to the client communication engine;
detecting an absence of an acknowledgement of receipt of the response message sent by the client communication engine to the server communication engine, wherein the absence of an acknowledgement of receipt indicates that a purge message tagged with a first time-frame number is either not sent by the client communication engine or not received by the server communication engine;
attaching the response message for the operation to an acknowledgement message tagged with a third time-frame number;
sending the acknowledgement message tagged with the third time-frame number and attached with the response message for the operation; and
transmitting an acknowledgement of receipt of the response message by the client communication engine to the server communication engine, wherein the acknowledgement of receipt is a purge message tagged with a third time-frame number.

16. The method of claim 15, wherein when the transmission of the acknowledgement of receipt of the response message by the client communication engine is not received by the server communication engine:
sending a control message, tagged with a fourth time-frame number, by the client communication engine, to the server communication engine;
implicitly detecting, by the server communication engine, that the acknowledgement message tagged with the third time-frame number and attached with the response message was received by the client communication engine, wherein implicitly detecting is based on the receipt of the control message tagged with a fourth time-frame number by the server communication engine; and
sending a purge operation, by the server communication engine, to the server.

17. A non-transitory computer-readable medium storing a set of instructions for a remote procedure call, the set of instructions comprising:
one or more instructions that, when executed by one or more processors of a device, cause the device to:
broker client-server communications, wherein client-server communications include a client’s request message for an operation, a server’s response message with results of the operation, and a purge message acknowledging receipt of the results;
establish, through system messages, time-frames for client-server communications, wherein a system message is a control message or an acknowledgement message, and wherein time-frames are established to enable detection of client-server communications that have not been timely received;
tag the client-server communications with time-frame numbers corresponding to the time-frames in which each client-server communication is sent;
detect that at least one client-server communication, sent in one time-frame, is not received in a pre-determined number of subsequent time-frames; and
retransmit the at least one client-server communication.

18. A system for a remote procedure call comprising:
a processing circuitry; and
a memory, the memory containing instructions that, when executed by the processing circuitry, configure the system to:
broker client-server communications, wherein client-server communications include a client’s request message for an operation, a server’s response message with results of the operation, and a purge message acknowledging receipt of the results;
establish, through system messages, time-frames for client-server communications, wherein a system message is a control message or an acknowledgement message, and wherein time-frames are established to enable detection of client-server communications that have not been timely received;
tag the client-server communications with time-frame numbers corresponding to the time-frames in which each client-server communication is sent;
detect that at least one client-server communication, sent in one time-frame, is not received in a pre-determined number of subsequent time-frames; and
retransmit the at least one client-server communication.
